(19) United States
(12) Patent Application Publication
(10) Pub. No.: US 2019/0065303 A1
(43) Pub. Date: Feb. 28, 2019

(54) PROCESSOR ANALYSIS

(71) Applicant: Hewlett Packard Enterprise Development LP, Houston, TX (US)

(72) Inventors: Andre Beaudin, Montreal (CA); Qiang Zhou, Beijing (CN); Mohd Shahnawaz Siraj, San Jose, CA (US)

(21) Appl. No.: 15/693,308

(22) Filed: Aug. 31, 2017

(51) Int. Cl. G06F 11/10

(52) U.S. Cl. CPC G06F 11/10; H04W 88/08

(57) ABSTRACT

Example implementations of an apparatus may comprise a first processing resource coupled to a second processing resource. The first processing resource may execute instructions to analyze an exception generated from the second processing resource, and identify a bit error on the second processing resource when the analysis of the exception indicates that the exception relates to the bit error on the second processing resource.

### BACKGROUND

An access point (AP) may be a networking hardware device that can allow a wireless-compliant device such as a station to connect to a network. The AP may include a processor and a co-processor. The co-processor may control operation of a radio, which may facilitate communication between the AP and a station.

### BRIEF DESCRIPTION OF THE DRAWINGS

FIG. 1 illustrates a diagram of an example of a first processing resource including instructions and a second processing resource consistent with the disclosure.

FIG. 2 illustrates a diagram of an example of an access point including a main processor and a co-processor consistent with the disclosure.

FIG. 3 illustrates a diagram of an example of a non-transitory computer readable medium for a processor analysis consistent with the disclosure.

### DETAILED DESCRIPTION

Wireless networks may be deployed to provide various types of communication to multiple users through the air using electromagnetic waves generated by a radio or radios. As a result, various types of communication may be provided to multiple users without cables, wires, or other physical electric conductors to couple devices in the wireless network. Examples of the various types of communication that may be provided by wireless networks include voice communication, data communication, multimedia services, etc.

An example of a wireless network is a wireless local area network (WLAN). As used herein, wireless local area network (WLAN) may refer to a communications network that links two or more devices using some wireless distribution method (for example, spread-spectrum or orthogonal frequency-division multiplexing radio). The WLAN may provide a connection through an access point to the Internet; and thus, providing users with the mobility to move around within a local coverage area and still stay connected to the network. WLANs may include multiple stations (STAs) and/or access points (APs) that may communicate over a plurality of wireless channels. An AP may be a networking hardware device that can allow a wireless-compliant device (e.g., a STA) to connect to a network. The STAs and/or APs may include a radio or radios to communicate and/or exchange information over the plurality of wireless channels. As used herein, information is generally defined as data, address, control, management (e.g., statistics) or any combination thereof. For transmission, information may be transmitted as a message, namely a collection of bits in a predetermined format. One type of message, namely a wireless message, includes a header and payload data having a predetermined number of bits of information. The wireless message may be placed in a format such as a plurality of packets, frames, or cells. As used herein, a “radio” is an antenna or aerial which converts electric power into electromagnetic waves and vice versa.

An AP may provide connectivity with a network such as the internet to the STAs. As used herein, AP generally refers to receiving points for a known or convenient wireless technology which may later become known. Specifically, the term AP is not intended to be limited to Institute of Electrical and Electronics Engineers (IEEE) 802.11-based APs. APs generally function as an electronic device that is adapted to allow wireless devices to connect to a wired network via various communications standards. As used herein, a STA is a device that has the capability to use the IEEE 802.11 protocol. Examples of STAs include smart phones, laptops, physical non-virtualized computing devices, personal digital assistants, etc. In some examples, a STA may be a device that contains an IEEE 802.11-conformant media access control (MAC) and physical layer (PHY) interface to a wireless medium (WM).

Wireless networks such as WLANs can use various wireless communication technologies. As an example, WLANs may use orthogonal frequency division multiplexing (OFDM). In an OFDM based wireless network, a data stream is split into multiple data substreams. Such data substreams may be sent over different OFDM subcarriers, which can be referred to as tones or frequency tones. Some wireless networks may use a single-in-single-out (SISO) communication approach, where each STA and/or AP uses a single antenna. Other wireless networks may use a multiple-in-multiple-out (MIMO) communication approach, where a STA and/or AP uses multiple transmit radios and multiple receive radios. WLANs such as those defined in the IEEE wireless communications standards, e.g., IEEE 802.11a, IEEE 802.11n, IEEE 802.11ac, etc. can use OFDM to transmit and receive signals. Moreover, WLANs, such as those based on the IEEE 802.11n or IEEE 802.11 ac standards, can use OFDM and MIMO.

In some approaches, an AP may include a processing resource (e.g., a processor), and a co-processing resource (e.g., a co-processor) or co-processing resources (e.g., co-processors). The processing resource and/or co-processing resource(s) may include hardware processors, microprocessors, etc. The co-processing resource(s) may be used to offload tasks from the processing resource. For example, time sensitive and/or repetitive tasks may be offloaded from the processor to the co-processor(s). The terms “processing resource” and “processor” are used interchangeably herein.

The interface may be, for example, a hardware component connected to the processor and the co-processor(s) and may allow for signals to be exchanged between the processor and the co-processor(s). The bus may be, for example, a peripheral component interconnect (PCI) bus, or a PCI express bus. In some examples, the bus may allow for signals and/or information (e.g., data) to be exchanged between the processor and the co-processor(s). As used herein, ‘interconnect’ or used descriptively as ‘interconnected’ is generally defined as a communication pathway established over an information-carrying medium. The ‘interconnect’ may be a wired interconnect, wherein the medium is a physical medium (e.g., electrical wire, optical fiber, cable, bus traces, etc.), a wireless interconnect (e.g., air in combination with wireless signaling technology) or a combination of these technologies.

In some examples, the co-processor(s) may be built on the access point with a structural and/or functional limitations. For example, a mechanical and/or electrical structure of the co-processor may be simplified to reduce cost associated with the access point. As such, in some approaches, the co-processor(s) may not be properly recovered from failures. For example, the co-processor(s) may not be provided with means to alert and identify an issue associated with the failures and/or means to recover the issue associated with the failures. Therefore, in some approaches, a failure of the co-processor(s) may often lead to a replacement of the co-processor(s) and/or an access point even when the co-processor(s) are easily correctable.

In contrast, examples herein may allow for detection and/or recovery of a co-processor failure. For example, a processor may monitor a co-processor for activity. The activity may include an exception generated on the co-processor and be received by the processor via a bus. In some examples, the co-processor may generate the exception in response to an abnormal state of the co-processor including, but not limited to, a bit error on the co-processor. As used herein, the bit error is an example measurement of wireless transmission quality. For example, the number of bit errors may refer to the number of received bits of a data stream over a communication channel that have been altered due to noise, interference, distortion or bit synchronization errors. In response to receiving the exception from the co-processor, the processor may analyze the exception to determine whether the exception relates to the bit error on the co-processor and correct the bit error in response to a determination that a bit error is correctable.

Therefore, examples of the present disclosure include apparatuses and computer-readable media storing executable instructions for a processor analysis. For example, apparatuses and machine-readable media storing executable instructions may allow for processor (e.g., co-processor) analysis. In some examples, an apparatus may comprise a first processing resource coupled to a second processing resource. The first processing resource may execute instructions to analyze an exception generated from the second processing resource, and identify a bit error on the second processing resource when the analysis of the exception indicates that the exception relates to the bit error on the second processing resource.

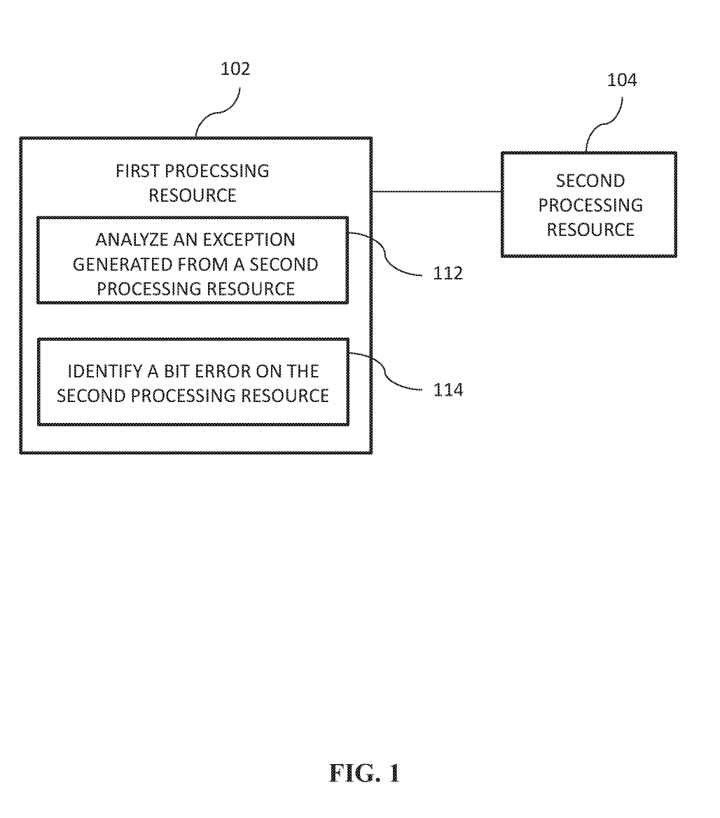

FIG. 1 illustrates an example of a first processing resource 102 including instructions (e.g., instructions 112 and 114) and a second processing resource 104 consistent with the disclosure. The first processing resource 102 may be a processor (e.g., a main processor), and the second processing resource 104 may be a co-processor. The instructions may be stored on a non-transitory machine readable medium (not shown in FIG. 1) that is included in the first processing resource 102 (or remotely coupled to the first processing resource 102). The non-transitory machine readable medium may be any type of volatile or non-volatile memory or storage, such as random access memory (RAM), flash memory, read-only memory (ROM), storage volumes, a hard disk, or a combination thereof.

The first processing resource 102 may be physically coupled to the second processing resource 104, for example, via a bus. In some examples, the first processing resource 102 may monitor activity of and exchange signals with the second processing resource 104 via the bus. For example, the first processing resource 102 may monitor the second processing resource 104 to determine whether an exception is generated from the second processing resource 104. The exception generated on the second processing resource 104 may be received by the first processing resource 102 via the bus.

Instruction 112, when executed by the first processing resource 102, may cause the first processing resource 102 to analyze an exception generated from the second processing resource 104. The second processing resource 104 may generate an exception in response to various states of the second processing resource 104 such as an abnormal state. As used herein, an exception refers to an exceptional state of a system (e.g., processing resource) that may adversely and/or abnormally affect a normal flow of program execution. The abnormal state may include a bit error on the second processing resource 104. For example, the bit error may include unintentional change in a bit value (from predetermined state such as “O” to a programmed stated such as “1” or vice versa) of a data pattern stored on the second processing resource 104. Such an abnormal state may cause the second processing resource 104 to generate the exception. However, the exception may be generic to the abnormal state and not specific to an issue (e.g., bit error) associated with the exception. For example, the second processing resource 104 may be designed, for various reasons, to lack an ability to analyze the exception. As such, merely generating the exception may not provide the second processing resource 104 information (e.g., issue) of what caused the abnormal state. Therefore, analyzing the exception at the first processing resource 102 may identify issues associated with the exception and recover the abnormal state of the second processing resource 104 while simplified structural and functional designs of the second processing resource 104 is maintained.

The first processing resource 102 and the second processing resource 104 may be included in a same device such as an access point. For example, the second processing resource 104 may be coupled to a radio of the access point.

In some approaches, the first processing resource 102 and the second processing resource 104 may operate in distinct operating environments, and may interact via an interface (e.g., a hardware interface) and/or a bus. For example, the first processing resource 102 may operate according to a first operating environment, and the second processing resource 104 may operate according to a second operating environment. As used herein, an “operating environment” is a set of instructions associated with a particular application. For example, an operating environment may include an operating system, database system, development tools, and/or a compiler associated with a particular application or applications.

In some examples, the second operating environment (e.g., of the second processing resource 104) may be derived from the first operating environment (e.g., of the first processing resource 102). For example, the second operating environment may be time sensitive and/or repetitive tasks that may be assigned from (e.g., offloaded from) the first operating environment.

Instructions 114, when executed by the first processing resource 102, may cause the first processing resource 102 to identify a bit error on the second processing resource 104 when the analysis of the exception indicates that the exception relates to the bit error on the second processing resource 104. In response to identifying the bit error on the second processing resource 104, the first processing resource 102 may correct the bit error identified on the second processing resource 104.

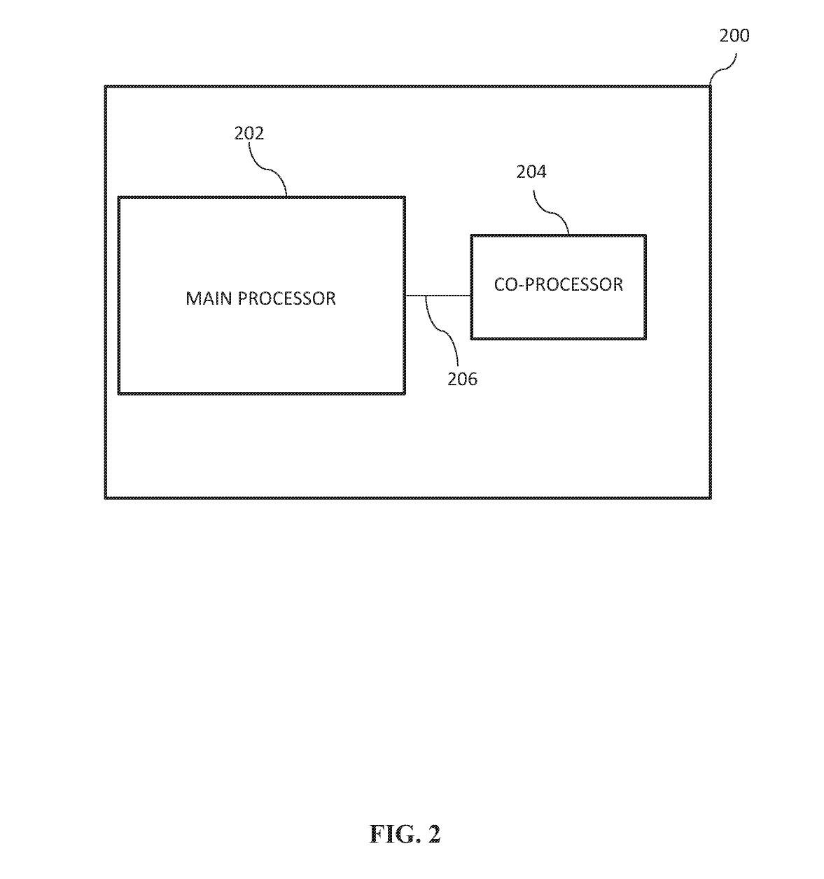

FIG. 2 illustrates a diagram of an example of an access point 200 including a main processor 202 and a co-processor 204 consistent with the disclosure. As illustrated in FIG. 2, the main processor 202 and the co-processor 204 included in the access point 200 may be coupled to one another by a bus 206. In some examples, the bus 206 may be PCI express bus. In some examples, a portion of tasks of the main processor 202 may be offloaded to the coprocessor 204 to accelerate system performance. As described herein, the main processor 202 may monitor activity of and exchange signals with the co-processor 204 via the bus 206 (e.g., PCI express).

In some examples, the co-processor 204 may be a radio processor of the access point. For example, the co-processor 204 may be coupled to a radio (e.g., not shown in FIG. 2). In some examples, the radio may include an antenna, which may transmit and/or receive electromagnetic radiation (e.g., radio signals). The co-processor 204 may control operation of the radio to, for example, control transmission and/or receipt of the electromagnetic radiation.

Co-processor 204 may include a non-transitory machine readable medium that may be any type of volatile or non-volatile memory or storage, such as random access memory (RAM), flash memory, read-only memory (ROM), storage volumes, a hard disk, or a combination thereof. The co-processor 204 may store instructions in the non-transitory machine readable medium to perform time sensitive and/or repetitive tasks that may be offloaded from the main processor 202.

In some examples, the co-processor 204 may lack an ability to identify an issue associated with the exception due to structural and/or functional limitations of the co-processor 204, among others. For example, a functional design of the co-processor 204 may be simplified to merely execute time sensitive and/or repetitive tasks on behalf of the main processor 202 such that the co-processor 204 need not execute complicated tasks such as analyzing and identifying the issue associated with the exception. For example, the co-processor 204 as a radio processor may be structurally simplified such that the co-processor 204 may lack a corresponding circuit to analyze and identify the issue associated with the exception. As such, in some approaches, correctable abnormal state and/or errors on the co-processor 204 often led to a replacement of the erroneous co-processor 204. Examples of the disclosure provides benefits such as providing analysis mechanism to the access point (e.g., particularly at the main processor 202) such that issues associated with the exception generated on the co-processor 204 may be identified and recovered without a replacement.

In various examples, the main processor 202 may analyze an exception generated on the co-processor 204 to determine whether the exception relates to a bit error on the co-processor 204. In some examples, analyzing the exception generated on the co-processor 204 may include decoding the exception generated on the co-processor 204, as further described herein.

In various examples, the exception may be analyzed to reveal an issue associated with the exception such that the issue is known to the access point at the time or subsequent to the analysis of the exception. For example, the exception may be generated on the co-processor 204 due to reasons other than the bit error. As such, without further analyzing (e.g., decoding) the exception, the access point 200 may not know what caused the exception. Stated differently, the co-processor 204 may not know the nature of the exception since the exception may be transmitted to the main processor 202 without being analyzed at the co-processor 204.

In various examples, the main processor 202 may execute a signature on the co-processor 204 and determine, in response to the signature executed on the co-processor 204, a location on the co-processor 204 including the bit error. As used herein, a signature may refer to a function, subroutine and/or method that defines inputs and outputs for those. For example, the signature may be a function that may be executed on and use a particular data pattern as an input. The signature may define an expected output executed on the data pattern, and one may recognize a bit change (e.g., that the data pattern includes a bit error) when the output obtained from executing the signature on the data pattern differs from the expected output.

In various examples, the main processor 202 may compare outputs of two signatures executed on the co-processor 204 to determine the location including the bit error. For example, the main processor 202 may execute signatures on locations of the co-processor 204 (e.g., periodically) such that the signatures are executed on the locations prior to and subsequent to the generation of the exception on the co-processor 204. In response to the signatures on the co-processor 204, the main processor 202 may compare an output of a first signature executed on a particular location prior to the generation of the exception, and an output of a second signature executed on a same location subsequent to the generation of the exception. When, for example, the outputs of the first and second signatures executed on the same location differ from each other, the main processor 202 may determine that the bit error identified by the exception occurred at the particular location.

As such, examples of the disclosure provides benefits such as providing the access point 200 a mechanism to locate and/or correct the bit error on the co-processor 204 while maintaining simplified structural and/or functional designs of the co-processor 204. The simplified structural and/or functional designs of the co-processor 204 is maintained since the mechanism to locate and/or correct the bit error on the co-processor is executed by the main processor 202.

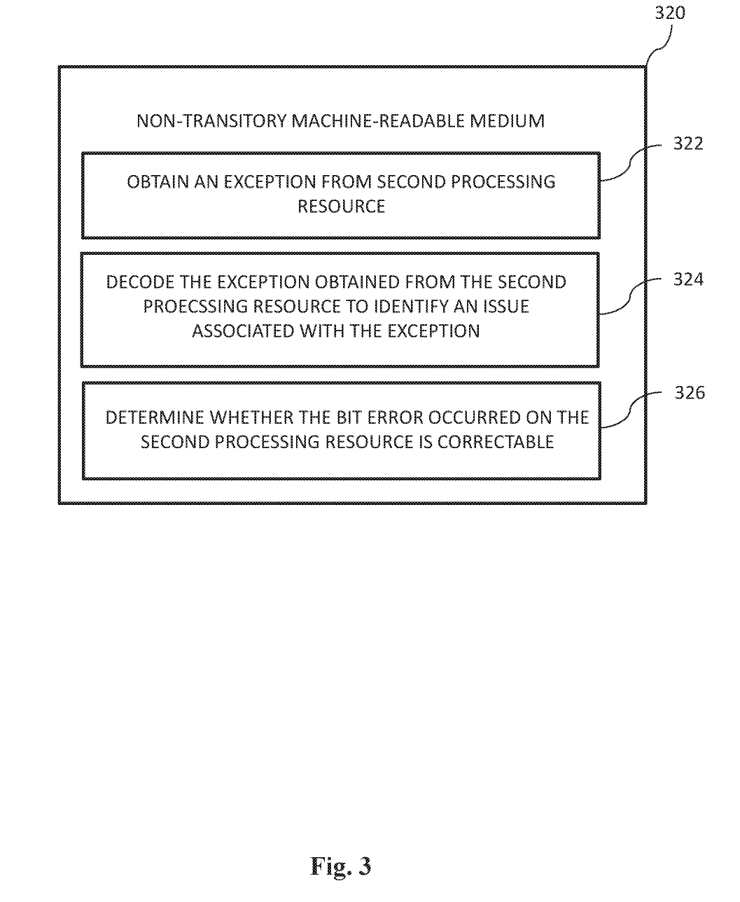

FIG. 3 illustrates a diagram of an example of a non-transitory computer readable medium 320 for a processor analysis consistent with the disclosure. The non-transitory machine readable medium 320 may be any type of volatile or non-volatile memory or storage, such as random access memory (RAM), flash memory, read-only memory (ROM), storage volumes, a hard disk, or a combination thereof. In various examples, the non-transitory computer readable medium 320 may be included in and/or coupled to the first processing resource, which may be a main processor of an access point.

The medium 320 may include instruction 322, when executed by the first processing resource, to obtain, in response to a generation of an exception on second processing resource, the exception from the second processing resource. As described herein, the first processing resource may be coupled to the second processing resource (e.g., co-processor), for example, via a bus. The bus coupled to the first processing resource and the second processing resource may be utilized to exchange signals between those.

The medium 320 may include instruction 324, when executed by the first processing resource, to decode the exception generated at the first processing resource to identify an issue associated with the exception. The second processing resource may generate the exception in response to an abnormal state including, but not limited to, a bit error in the second processing resource. However, the exception that is generated in response to the errors may not specifically indicate the issue associated with the exception (e.g., that the exception occurred due to a bit error). For example, without decoding the exception, an access point (e.g., including the first processing resource and the second processing resource) may not know what caused the exception and/or a location of a bit error on the second processing resource (e.g., if the exception relates to the bit error). As such, the issue associated with the exception may not be revealed when the exception is generated at the second processing resource.

The exception generated on the second processing resource may be transmitted to the first processing resource without being decoded at the second processing resource. The second processing resource without an ability to decode the exception may provide benefits such as reducing cost associated with the co-processor(s) and/or an access point by simplifying structural and/or functional designs of the co-processor(s). The exception transmitted from the second processing resource may be decoded at the first processing resource. Stated differently, the issue associated with the exception may be known to the access point when the exception is decoded at the first processing resource. Stated further differently, the issue associated with the exception may be unknown to the second processing resource since the exception is transmitted from the second processing resource to the first processing resource without being decoded at the second processing resource.

The medium 320 may include instruction 326, when executed by the first processing resource, to determine, when the identified issue relates to a bit error on the second processing resource, whether the bit error occurred on the second processing resource is correctable. In various examples, the first processing resource may correct the bit error on the second processing resource, for example, in response to a determination that the bit error is correctable. Correcting the bit error on the second processing resource may be associated with utilizing parity bits and/or error correction code (ECC) stored on the first processing resource and/or the second processing resource. In some examples, the first processing resource (e.g., main processor) may determine to utilize parity bits (and/or ECC) stored on the second processing resource (e.g., co-processor) to correct the bit error. In some examples, the first processing resource (e.g., main processor) may utilize parity bits (and/or ECC) stored on the first processing resource and corresponding to data patterns stored on the second processing resource (e.g., co-processor) to correct the bit error. Although examples are not so limited, ECC may include a low-density parity-check (LDPC), Bose-Chaudhuri-Hocquenghen (BCH) and/or Reed-Solomon (RS).

In some examples, the medium 320 may include instructions to report the bit error, for example, when the bit error is determined to be not correctable. In this event, a user may choose to replace the failed co-processor.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure. As used herein, designators such as “N”, etc., particularly with respect to reference numerals in the drawings, indicate that a number of the particular feature so designated can be included. As used herein, “a number of” a particular thing can refer to of such things (e.g., a number of computing devices can refer to computing devices). A “plurality of” is intended to refer to more than one of such things. Multiple like elements may be referenced herein generally by their reference numeral without a specific identifier at the end.

The figures herein follow a numbering convention in which the first digit corresponds to the drawing figure number and the remaining digits identify an element or component in the drawing. For example, reference numeral 104 may refer to element “04” in FIG. 1 and an analogous element may be identified by reference numeral 204 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

What is claimed:

1. An apparatus, comprising:
a first processing resource coupled to a second processing resource; the first processing resource to execute instructions to:
analyze an exception generated from the second processing resource; and
identify a bit error on the second processing resource when the analysis of the exception indicates that the exception relates to the bit error on the second processing resource.

2. The apparatus of claim 1, comprising instructions executable by the first processing resource to correct the identified bit error on the second processing resource.

3. The apparatus of claim 1, wherein the first processing resource operates according to a first operating environment and the second processing resource operates according to a second operating environment.

4. The apparatus of claim 1, wherein first processing resource and the second processing resource are included in an access point, and wherein the second processing resource is coupled to a radio of the access point.

5. The apparatus of claim 1, wherein the first processing resource is a main processor and the second processing resource is a co-processor.

6. The apparatus of claim 1, wherein the first processing resource is physically coupled to the second processing resource.

7. An access point, comprising:
a co-processor to generate an exception; and
a main processor coupled via a bus to the co-processor to:
analyze the exception generated on the co-processor to determine whether the exception relates to a bit error on the co-processor;
execute a signature on the co-processor; and
determine, in response to the signature executed on the co-processor, a location on the co-processor including the bit error.

8. The access point of claim 7, wherein the main processor is to compare outputs of a first signature and a second signature executed on the co-processor to determine the location including the bit error.

9. The access point of claim 8, wherein:
the first signature is executed on the location prior to the generation of the exception; and
the second signature is executed on the location subsequent to the generation of the exception.

10. The access point of claim 7, wherein the exception is analyzed to reveal an issue associated with the exception such that the issue is known to the access point at the time or subsequent to the analysis of the exception.

11. The access point of claim 7, wherein the exception generated at the co-processor is transmitted to the main processor without being analyzed at the co-processor.

12. The access point of claim 7, wherein the exception is generated in response to an abnormal state of the co-processor.

13. The access point of claim 7, wherein the co-processor is a radio processor of the access point.

14. The access point of claim 7, wherein the bus is a peripheral component interconnect express (PCle) bus.

15. A non-transitory machine readable medium comprising instructions executable by a first processing resource to:
obtain, in response to a generation of an exception on second processing resource, the exception from the second processing resource;
decode the exception obtained from the second processing resource to identify an issue associated with the exception; and
determine, when the identified issue relates to a bit error on the second processing resource, whether the bit error occurred on the second processing resource is correctable.

16. The medium of claim 15, wherein the issue associated with the exception is revealed when the exception is decoded at the first processing resource.

17. The medium of claim 15, wherein the exception generated from the second processing resource is transmitted to the processing resource without being decoded such that the issue associated with the exception is unknown to the second processing resource.

18. The medium of claim 15, comprising instructions to correct the bit error on the second processing resource.

19. The medium of claim 15, comprising instructions to correct the bit error on the second processing resource by utilizing a parity bit stored on a second processing resource.

20. The medium of claim 15, comprising instructions to report that the bit error is not correctable in response to a determination that the bit error is not correctable.
